(19) United States
(12) Patent Application Publication
(10) Pub. No.: US 2004/0222310 A1
(43) Pub. Date: Nov. 11, 2004

(54) Method of spray polyurethane application utilizing internally mixed components applied with a flat fan spray

(75) Inventors: Joseph T. Donatti, Howell, MI (US); Andrew P. Mellentine, Owosso, MI (US); Glenn D. Williams, Holly, MI (US); Glenn A. Cowelchuk, Chesterfield, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI

(21) Appl. No.: 10/430,995

(22) Filed: May 7, 2003

(51) Int. Cl. B05B 17/04; B05B 3/00; B05B 1/32

(52) U.S. Cl. 239/11; 239/225.1; 239/451

(57) ABSTRACT

A method of spray forming articles with a nozzle that sprays in a flat fan-shaped spray pattern. The process may be used to form articles from a polyurethane composition. Repeated passes of the nozzle that partially overlap apply a deposit in a series of parallel paths. A primary flat fan-shaped spray is flanked by a pair of secondary sprays that are outboard of the primary spray. The secondary sprays facilitate feathering the edges of adjacent deposits and provide a spray application having a consistent thickness.

### BACKGROUND OF THE INVENTION

1. Field of the Invention

The present invention relates to spray forming polyurethane articles using a spray nozzle that directs a flat fan-shaped spray pattern.

2. Background Art

Spray forming articles with polyurethane elastomer is a relatively new process that holds much promise for manufacturing high quality, durable parts. Parts that may be made with the polyurethane spray forming process include automotive interior parts as well as other parts. Some automotive interior parts that may be made using a polyurethane skin or polyurethane layer include instrument panel covers, console covers, inner door panels, glove box covers, floor mats, steering column covers, and knee bolsters, and the like.

Earlier attempts to manufacture polyurethane parts by a spray forming process have required expensive spray nozzle tips that are used to form a conical spray pattern. These elaborate spray nozzle tips, in addition to being expensive, require frequent maintenance and cleaning to assure proper performance. A conical spray pattern yields a slightly cupped spray deposit in cross-section with a portion near the outer edges of the spray deposit being thicker than the central portion.

FIGS. 1, 2 and 6 are schematic representations of a spray deposits from a conical spray gun. To make a continuous skin, several spray passes must be laid down next to each other. Increased accumulation of the spray deposit on the outer edges of each deposit made by a spray pass can result in a ribbed appearance on the back side of the spray applied layer. While the ribbed appearance is not generally visible on the mold side or exterior surface of a part, in some instances it may be detectable as an area of different thickness and possibly different hardness compared to the other parts of the skin. Skin thickness variations may cause problems relating to attachment to plastic and metal retainers and may also adversely impact foam thickness uniformity.

With conical type sprays it is sometimes difficult to access tight areas that have an aspect to width ratio of less than 2 to 1. For example, difficult to spray portions of parts may include an instrument panel brow, a demister area on a dashboard, or an air conditioning vent on a dashboard because they require spray forming of deeply recessed areas.

Conical sprays generally result in higher quantities of over spray. Over spray can be in the range of 15% of the volume sprayed. Accumulations of over spray outside the useable area of a mold wastes material, burdens air handling systems and creates an unsightly mess inside spray booths.

Prior art conical spray patterns require high pressure spray equipment that is designed to operate at 1000 to 2000 psi. Conical spray patterns at such pressures may be used to spray polyurethane at a rate of 16 to 24 grams per second. Processes requiring higher pressures generally require higher capital investments. An application rate of 16 to 24 grams per second is the norm and higher productivity could be obtained if the spray application rate could be increased without increasing pressure, velocity and turbulence of the spray.

These and other problems are addressed by applicants' invention as summarized below.

### SUMMARY OF THE INVENTION

According to one aspect of the present invention, a method is provided for spray application of polyurethane used to spray form an article. The method includes supplying a polyurethane composition to a spray nozzle that sprays the polyurethane composition in a flat fan-shaped pattern onto a mold surface. A swath of polyurethane is applied to the mold surface as the nozzle and mold surface are moved relative to each other in a predetermined path. A skin is created by partially overlapping swaths that are applied in multiple passes of the nozzle relative to the mold. The skin layer formed has a substantially consistent thickness due to the flat fan-shaped spray pattern in comparison to prior art methods that employ conical spray patterns.

According to other aspects of the invention, the polyurethane composition may be sprayed with a primary flat fan-shaped pattern as previously described plus a pair of secondary spray patterns that are formed outboard of the wide portion of the flat fan-shaped spray pattern. The secondary spray patterns may facilitate feathering the edges of the spray pattern over adjacent overlapping swaths.

According to other aspects of the invention relating to the path of movement of the nozzle and mold surface relative to each other, the path followed is one characterized by parallel strips that overlap about 30% of at least one adjacent strip. The path followed in the moving step may be repeated in at least two layers with the parallel strips in each of the layers being disposed at right angles to the parallel strips in a lower layer.

According to another aspect of the invention as it relates to the composition sprayed, the composition may be a two component aromatic polyurethane mixture of polyol and isocyanate. Alternatively, the polyurethane mixture could be an aliphatic polyurethane. The two component mixture is first mixed in the mixing chamber of the high pressure mixing head and then internally mixed in a spray applicator having a helical mixing element that mixes the polyol and isocyanate prior to being sprayed by the spray nozzle. The mixture is then sprayed on an in-mold coating that was previously applied to the mold surface to provide color and gloss on the finished product.

The polyurethane mixture may be sprayed at a pressure ranging from 400 psi to 1200 psi through the nozzle that is used to form the flat fan-shaped spray pattern. Reductions in pressure and spray velocity result in less over spray compared to conical spray patterns.

These and other aspects of the invention will be readily apparent in view of the attached drawings and following detailed description.

### BRIEF DESCRIPTION OF THE DRAWINGS

FIG. 1 is a diagrammatic perspective view of a prior art spray forming process utilizing a nozzle that provides a conical spray pattern;

FIG. 2 is a cross-sectional view taken along line 2-2 in FIG. 1;

FIG. 3 is a schematic perspective view of the spray forming process of the present invention using a nozzle that provides a flat fan-shaped spray pattern;

FIG. 4 is a cross-sectional view taken along line 4-4 in FIG. 3;

FIG. 5 is a cross-sectional view of the spray deposited by the flat fan-shaped nozzle made in accordance with the present invention on a series of passes;

FIG. 6 is a cross-sectional view of the spray deposited by the process of FIG. 1 in a series of passes;

FIG. 7A is a cross-sectional view of a static mixer and an in line spray nozzle made in accordance with the present invention;

FIG. 7B is a cross-sectional view of an alternative designs for a spray nozzle having a nozzle orifice at a 90 degree angular orientation;

FIG. 8 is an end view of the static mixer and nozzle shown in FIG. 7;

FIG. 9 is a cross-sectional view of a nozzle for forming a flat fan-shaped spray pattern according to the present invention; and

FIG. 10 is a schematic view of a nozzle tip illustrating measured dimensions for forming a flat fan-shaped spray according to the present invention.

### DETAILED DESCRIPTION OF THE PREFERRED EMBODIMENT(S)

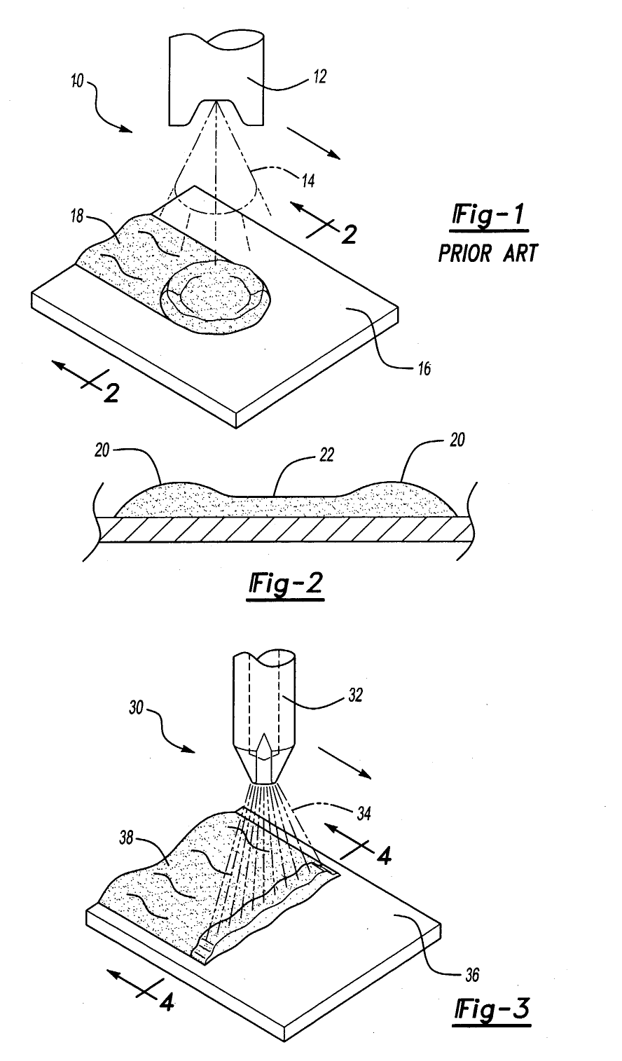

Referring now to FIGS. 1 and 2, the prior art conical spray forming process is generally indicated by reference numeral 10. A conical spray applicator 12 sprays a conical spray 14 onto a mold 16. The conical spray 14 forms a spray deposit 18 in a partial toroidal shape as the applicator 12 moves relative to the mold 16. Either the mold 16, applicator 12 or both may move with the result that the spray deposit 18 is spread in a linear manner. Referring to FIG. 2, the prior art spray deposit 18 formed with a conical spray pattern tends to create a deposit with a reverse curve distribution having thick outer portions 20 developing on opposite sides of a center portion 22.

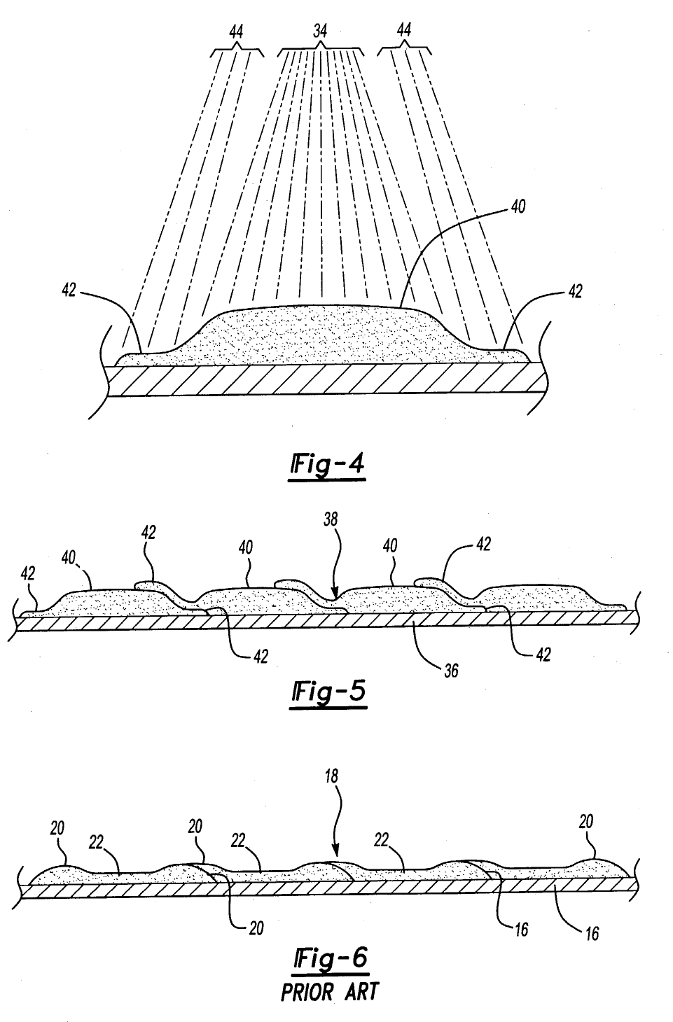

Referring to FIGS. 3 and 4, a flat fan spray forming process is generally indicated by reference numeral 30. A flat fan spray applicator 32 directs a flat fan spray 34 toward a mold 36, or mold surface, on which a spray deposit 38 is applied. The spray applicator 32 and mold 36 move relative to each other with either or both being movable. The flat fan spray applicator 32 applies a primary spray deposit 40 on the mold 36. Secondary spray deposits 42 are inherently formed by the flat fan spray applicator 32 that sprays a secondary spray 44 on either side of the primary spray deposit 40. The primary spray deposit 40 is emitted in a generally rectangular shape having an elongated side and a short side. The secondary spray deposit 42 is formed outboard of the short sides of the primary spray deposit 40, as shown in FIG. 4.

Referring now to FIG. 5, an advantage of the flat fan spray process is illustrated wherein improved feathering of the urethane fan pattern provides a more even distribution of polyurethane on the mold surface. The product of multiple spray passes is shown in cross section wherein a primary spray deposit 40 and two secondary spray deposits 42 are sprayed in an overlapping relationship. The amount of overlap may vary. However, an acceptable overlap has been achieved with 30% overlap between adjacent spray passes. It is believed that this may vary from 10% to 30% overlap. However, with the nozzle tested and illustrated, the overlap of 30% creates an even distribution of spray elastomer on the mold surface 36.

Referring now to FIG. 6, the result of multiple passes using the prior art conical spray forming process identified by reference numeral 10 above is shown wherein the spray deposit 18 is made up of a center portion 22 flanked by thick outer portions 20. When overlapping passes are made, two thick outer portions 20 of adjacent spray deposits 18 tend to overlap one another and create an uneven distribution that wastes polyurethane and provides unwanted variation in the thickness of the skin.

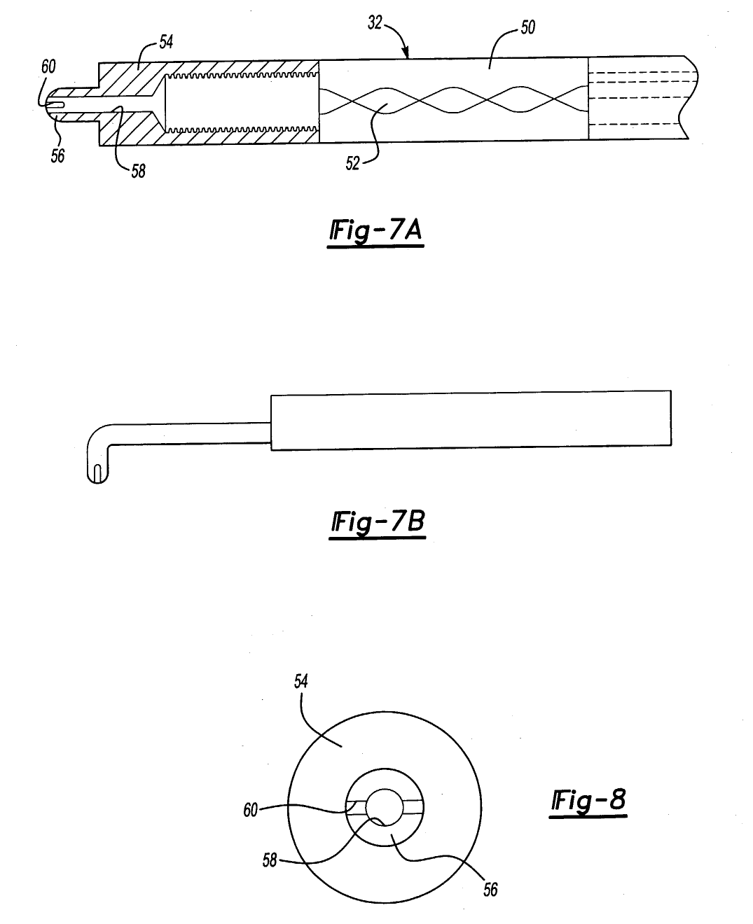

Referring now to FIGS. 7A and 8, a flat fan spray applicator 32 is shown to include a mixing chamber 50 that encloses a helical mixing element 52. The mixing chamber 50 is connected to nozzle body 54. A nozzle tip 56 is formed on the nozzle body 54 and will be described more specifically below. A channel 58 is formed in the nozzle body 54 through which the polyurethane composition, or liquid reaction mixture, is provided to the nozzle tip 56. A fan spray slot 60 is formed at the end of the nozzle tip 56 that directs the polyurethane into a flat fan spray 34.

Referring to FIGS. 7B, the direction of the flat fan shaped spray pattern may be changed to make it easier to program manipulation of the spray gun by the robot arm or to make it easier to reach difficult to access portions of a mold. FIG. 7A shows a straight through nozzle tip while FIG. 7B is of a 90 degree tip. Other angular spray directions may be obtained by curving the mixing wand to obtain any desired spray direction from 0 to 90 degrees.

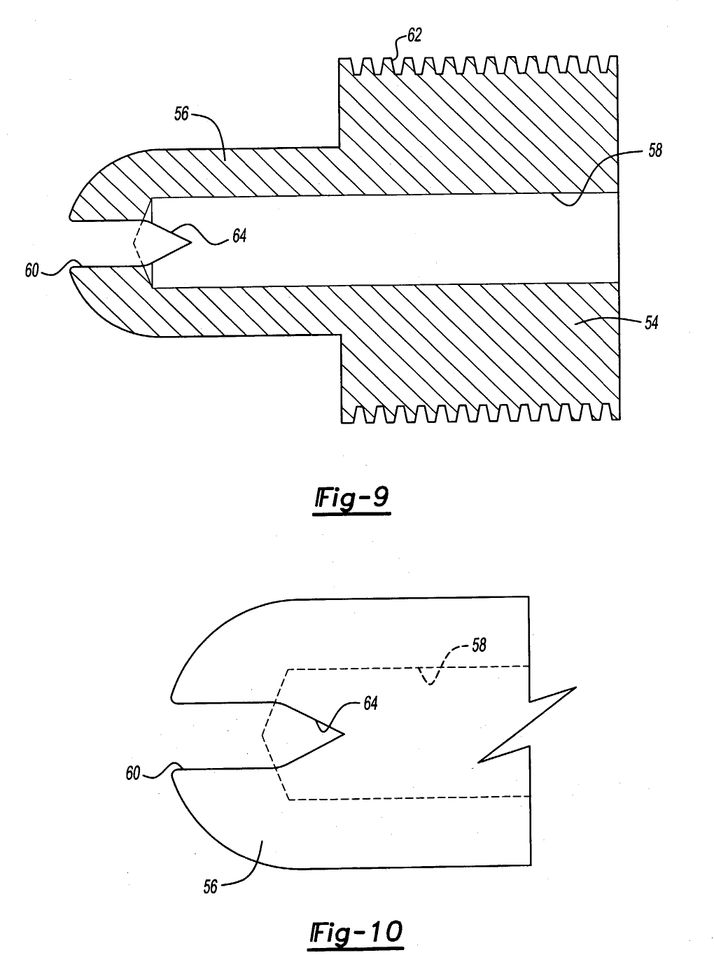

Referring to FIG. 9, the structure of the nozzle body 54 and nozzle tip 56 is shown in greater detail. The nozzle body includes a channel 58 that extends through the nozzle body 54 and into the nozzle tip 56. The fan spray slot 60 is provided in the nozzle tip 56. Threads 62 are formed on the nozzle body 54 that are used to secure the nozzle body to the mixing chamber 50. An angle cut slot 64 is formed at the base of the fan spray slot 60 that is provided to improve this region of the spray and also improve the ability to feather spray deposits from adjacent passes together.

Referring to FIG. 10, dimensions of the nozzle tip 56 are illustrated schematically wherein the slot width is dimension A. The slot depth is dimension B. The channel diameter is dimension C. The channel depth is dimension D and the angle of cut is dimension E. Based upon trial runs of the flat fan spray forming process, the dimensions in the following table have been identified as the best dimension and expected preferred range of dimensions for the conditions of the test. The best dimension is listed in the third column and the range of dimensions currently believed to be acceptable shown in the fourth column.

| | | | |
|---|---|---|---|
| A | Slot Width | 0.020″ | 0.008-0.025 |
| B | Slot Depth | 0.075″ | 0.050-0.075 |
| C | Channel Diameter (Drill) | 0.062″ | 0.031-0.067 |
| D | Channel Depth (Drill) | 0.942″ | 0.937-0.960 |
| E | Angle of Cut | 30° | 30°-50° |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for spray application of polyurethane for spray forming an article:
supplying a polyurethane composition to a spray nozzle:
spraying the polyurethane composition in a flat fan shaped pattern onto a mold surface to apply a single swath of polyurethane to the mold surface;
moving the nozzle and mold surface relative to each other in a path to create a skin layer with multiple partially overlapping swaths being applied in multiple passes of the nozzle relative to the mold, whereby a skin layer is formed that has a substantially consistent thickness.

2. The method of claim 1 wherein during the spraying step the polyurethane composition is also sprayed in a pair of secondary spray patterns are formed outboard of the wider portion of the flat fan shaped spray pattern.

3. The method of claim 1 wherein the path followed in the moving step is a path having parallel strips that overlap about 10 to 30% over at least one adjacent strip.

4. The method of claim 3 wherein the path followed in the moving step is repeated in at least two layers.

5. The method of claim 4 wherein the two layers are oriented with the parallel strips in each of the layers being disposed at right angles to each other.

6. The method of claim 4 wherein the two layers are oriented with the parallel strips in each of the layers being disposed parallel to each other.

7. The method of claim 1 wherein during the spraying step the polyurethane composition is also sprayed in a pair of secondary spray patterns are formed outboard of the wider portion of the flat fan shaped spray pattern and the secondary spray patterns are applied in a path having parallel strips with the secondary spray patterns overlapping the flat fan shaped spray pattern of at least one adjacent strip.

8. The method of claim 1 wherein the polyurethane composition is a two component aromatic polyurethane mixture of polyol and isocyanate that are internally mixed in a spray applicator having a helical mixing element that mixes the polyol and isocyanate prior to being sprayed by the spray nozzle.

9. A method for forming a polyurethane layer on a surface, comprising:
spraying a liquid reaction mixture comprising polyol and isocyanate, said mixture being sprayed in form of a flat fan shaped spray pattern onto a mold surface to apply a swath of the mixture to the mold surface; and
moving the nozzle relative to the mold surface in a path comprising a plurality of parallel adjacent strips that partially overlap, whereby a layer is formed that has a relatively consistent thickness.

10. The method of claim 9 wherein the liquid reaction mixture is also sprayed in a pair of secondary spray patterns are formed outboard of the wider portion of the flat fan shaped spray pattern.

11. The method of claim 9 wherein the path followed in the moving step is a path having parallel strips that overlap about 10 to 30% over at least one adjacent strip.

12. The method of claim 11 wherein the path followed in the moving step is repeated in at least two layers.

13. The method of claim 9 wherein spraying the liquid reaction mixture further comprises spraying a pair of secondary spray patterns outboard of the wider portion of the flat fan shaped spray pattern and the secondary spray patterns are applied in a path that is parallel to strips of the secondary spray patterns overlapping at least one adjacent strip.

14. The method of claim 9 wherein the liquid reaction mixture is a two component aromatic polyurethane mixture of polyol and isocyanate that are internally mixed in a spray applicator having a helical mixing element that mixes the polyol and isocyanate prior to being sprayed by the spray nozzle.

15. The method of claim 9 wherein the liquid reaction mixture is sprayed at a pressure of 400-1,000 psi.

16. The method of claim 9 wherein the liquid reaction mixture is sprayed on an in mold coating that was previously applied to the mold surface.

17. The method of claim 9 wherein the liquid reaction mixture is an aliphatic polyurethane mixture.
